(19) United States
(12) Patent Application Publication
(10) Pub. No.: US 2009/0311386 A1
(43) Pub. Date: Dec. 17, 2009

(54) Method For Making A Foodstuff

(76) Inventors: Pieter Coenraad Nell, URSEM (NL); Paulus Statius Reinier Kosters, APELDOORN (NL)

Correspondence Address: ST. ONGE STEWARD JOHNSTON & REENS, LLC, 986 BEDFORD STREET, STAMFORD, CT, 06905-5619, US

(21) Appl. No.: 12/544,792

(22) Filed: Aug. 20, 2009

Related U.S. Application Data
(63) Continuation of application No. PCT/NL2008/050092, filed on Feb. 19, 2008.

(30) Foreign Application Priority Data
Feb. 20, 2007 (NL) NL 2000497

(51) Int. Cl. A21D 13/06; A23L 1/212; A21D 13/00; A21D 2/36; A23L 1/29

(52) U.S. Cl. 426/92; 426/481; 426/615; 426/549; 426/646; 426/559; 426/556; 426/94; 426/102

(57) ABSTRACT

A method for making a food product that is suitable for human consumption, has a firm texture and is made from a mixture of protein-containing ingredients and vegetable. Finely ground vegetable is first dejuiced in a separating device, such as a decanter, a press or a centrifuge, and the dejuiced vegetable is then kneaded into the protein-containing ingredients without further processing. An ingredient for addition to food products suitable for human consumption, including dejuiced vegetable with a moisture content of at least 55%, is also contemplated. A dough or paste composed of protein, fat, starch, processing aids and vegetable, amongst other ingredients, whereby the vegetable is added in the form of a kneadable dejuiced vegetable, and also to products made from or with the dough or paste is further contemplated.

### CROSS-REFERENCE TO RELATED APPLICATIONS

The present application is a continuation of pending International patent application PCT/NL2008/050092 filed on Feb. 19, 2008 which designates the United States and claims priority from Netherlands patent application 2000497 filed on Feb. 20, 2007, the content of which is incorporated herein by reference.

### BACKGROUND OF THE INVENTION

Tests have shown that dejuiced vegetable is surprisingly well suited for processing into food products for human consumption as a source of gluten-free food fibres and for imparting a better structure to food products.

The use of food fibres in foodstuffs is rapidly gaining popularity, owing to their health-promoting effect. The disadvantage of the known food fibres is that the fibres used often contain gluten, which can provoke allergic reactions in some consumers. The use of dejuiced vegetable is a surprisingly simple way of being able to use gluten-free fibres in foodstuffs for human consumption.

The invention relates to a method for making a food product that is suitable for human consumption, has a firm texture and is made from a mixture of protein-containing ingredients comprising dough or paste for sausage products, meat products or bread and vegetable. Such a method is known from WO 9629891. The dejuiced vegetable, which is mixed into the food product by the known method, is dried to obtain a more or less crumbly product immediately after dejuicing, so that it can be mixed into the mixture of ingredients without kneading. The drawback of the known method is that the drying of the dejuiced vegetable needs extra energy.

### SUMMARY OF THE INVENTION

In order to eliminate this drawback, the method is carried out in that finely ground vegetable is first dejuiced in a separating device, such as a decanter, a press or a centrifuge, and the dejuiced vegetable is then kneaded into the protein-containing ingredients without further processing. This makes the vegetable suitable for mixing with the protein-containing ingredients by kneading.

According to one embodiment, the method is carried out whereby the dejuicing of the vegetable in the separating device is stopped before the moisture content of the dejuiced vegetable falls below 55%. This makes the dejuiced vegetable highly suitable for kneading into the protein-containing ingredients.

According to one embodiment, the method is carried out whereby the food product is a dough or paste containing protein, fat, starch, processing aids and the dejuiced vegetable, which dough or paste is heated for some time after the addition of the dejuiced vegetable. When the dejuiced vegetable is admixed to a dough or paste and this dough or paste is heated for some time, a firm product with a good texture and healthy composition is obtained.

According to one embodiment, the method is carried out whereby, prior to dejuicing, the vegetable is finely grounded in a grinding device which is adjusted such that the finely ground product is pumpable. When, prior to dejuicing, the vegetable is finely ground to obtain a pumpable product, the dejuicing is simpler, the remaining dejuiced vegetable can be readily processed into food products, and the food products acquire a fine texture.

According to one embodiment, the method is carried out whereby the grinding device is adjusted such that 80% of the particles of the pumpable product have a size smaller than 2.5 mm. When, prior to dejuicing, the fresh vegetable is comminuted into fine particles, the dejuicing is easier, the remaining dejuiced vegetable can be readily processed into food products, and the food products acquire a fine texture, possibly after heating.

According to one embodiment, the method is carried out whereby the vegetable is heated for a short time prior to dejuicing. This inactivates the enzymes, stabilizes the microbes, and improves the extraction of the juice from the vegetable.

According to one embodiment, the method is carried out whereby the separating device is adjusted such that, when the vegetable juice is being extracted from the vegetable, less than 50 wt % of the original amount of vegetable remains as dejuiced vegetable. As a result, the dejuiced vegetable contains food fibres in a high concentration, making it very suitable for use in food products.

According to one embodiment, the method is carried out whereby, directly after the extraction of the juice, the dejuiced vegetable is cooled and/or temporarily preserved in some other way and/or stored before being added to the protein-containing ingredients. Preservation of the dejuiced vegetable ensures that the dejuiced vegetable need not be used immediately and that the dejuiced vegetable can also be for example transported to a processing site. When the dejuiced vegetable is then added to the food product without further processing, as much of the nutrients from the vegetable is retained as possible.

According to one embodiment, the method is carried out whereby the food product with a firm texture consists of a mixture of protein-containing ingredients containing at least 5 wt % of dejuiced vegetable. This achieves a reasonable reduction in the fats and proteins in the food product, while the amount of gluten-free food fibres increases so much that a health effect can be expected of the food product.

According to one embodiment, the method is carried out whereby the food product with a firm texture consists of a mixture of protein-containing ingredients comprising dough or paste for sausage products, meat products or bread containing at least 20 wt % of dejuiced vegetable. This achieves an appreciable reduction in the fats and proteins in the food product, while the amount of gluten-free food fibres increases appreciably.

The invention also includes an ingredient for addition to dough or paste for sausage products, meat products or bread suitable for human consumption, comprising dejuiced vegetable with a moisture content of at least 55%. Such ingredients make a whole new series of food products possible, which have health-promoting effects and acquire a good texture by the application of simple measures.

According to one embodiment, the ingredients are composed in a manner whereby the dejuiced vegetable is subjected to an after-treatment to reduce its microbial count. As a result, the enzymes in the ingredients are inactivated and/or the microbes are stabilized without affecting the flavour of the ingredients, so that further processing is simplified.

The invention also includes a dough or paste used for making sausage products, meat products or bread suitable for human consumption, which dough or paste is composed of protein, fat, starch, processing aids and vegetable, amongst other ingredients. The use of vegetable in the dough or paste for the production of, for example, meat products is known from U.S. Pat. No. 5,766,667. This document mentions the use of liquefied vegetable in the preparation of meat blocks. The drawback of the known method is that all of the vegetable is used, so that the moisture introduced with the vegetable, including the carbohydrates present in it, is taken up in the dough or paste. As a result, the foodstuff lacks sufficient texture and/or firmness.

The use of vegetable in the dough or paste for the production of foodstuffs is also known for example from U.S. Pat. No. 3,903,313. In this document, the vegetable is first dewatered and then added as dry matter to the dough or paste. The drawback of this method is that a great deal of energy is needed for dewatering.

To eliminate the drawbacks mentioned above, the dough or paste is made whereby the vegetable is added in the form of a kneadable dejuiced vegetable. When vegetable is added in the form of dejuiced vegetable, all the required nutrients from the vegetable are introduced into the dough, and the dough or paste is kneadable and acquires a better texture and/or firmness, because a major part of the moisture present in the vegetable, with the carbohydrates dissolved in it, has been removed with the juice extracted.

According to one embodiment, the dough or paste is made whereby the fibre content of the dejuiced vegetable is at least twice as high as the fibre content of the vegetable. It has been found that a dejuiced vegetable with this composition readily mixes with the other ingredients of the dough or paste, as a result of which the foodstuff acquires a good texture and/or firmness.

According to one embodiment, the dough or paste is made whereby 80% of the particles of the dejuiced vegetable have a size smaller than 2.5 mm. When the vegetable is comminuted to obtain small particles, the dejuiced vegetable acquires a structure that makes it easy to mix with the dough or paste, so that the original structure of the vegetable is no longer fully visible in the foodstuff, but the dejuiced vegetable still contributes to the texture and/or firmness of the foodstuff.

The invention also includes meat products whereby the paste is partly composed of finely ground meat, and the paste is preferably warmed for a few hours at most. Warming the dough or paste achieves cohesion between the finely ground meat and the other ingredients, so that the meat products can be easily cut and have the required firmness. The meat products thus obtained contain less fat and proteins and more gluten-free food fibres and more moisture, so that they also have a lower calorie content and are therefore healthier.

The invention also includes bread and pastry products whereby the dough is baked in an oven. Bread and pastry products made with dejuiced vegetable have extra nutrients of plant origin and extra gluten-free food fibres, so they have more texture and/or firmness.

The invention also includes fried, baked and roasted products whereby the product is cooked in frying oil or in an oven. The fried products prepared with dejuiced vegetable contain extra nutrients of plant origin and extra gluten-free food fibres, so they have a better texture and/or firmness.

### DETAILED DESCRIPTION OF THE INVENTION

The invention is explained in more detail below with the aid of some examples.

Dejuiced carrot and other dejuiced vegetables were added to sausage products, meat products (including liver sausage) and bread in an amount of up to 23% of the mixture. The dejuiced vegetable was mixed into the sausage products, meat products or bread with the moist vegetable having a moisture content of at least 55% being kneaded into the dough or paste of the sausage products, meat products or bread. This kneading achieves a complete mixing of the dejuiced vegetable with the dough or paste, so the dejuiced vegetable adhered well to the dough or paste. The dejuiced vegetable ensured a surprisingly good texture, firmness and flavour experience. The influence exerted on the flavour and colour was naturally connected with the type of dejuiced vegetable used. In a vegetarian product, the undesirable perception of soya-bean flavour was adequately masked by the added dejuiced vegetable.

The washed vegetable or vegetable residue was ground in a coarsely cutting mill and possibly in a finely cutting mill in order to obtain a pumpable product. In the process, the vegetable acquired an average particle size of between 0.7 and 2.5 mm or a particle size where 80% of the particles were smaller than 2.5 mm. The finely ground product was transported further by pumping.

The pumpable product was optionally heated briefly to 70-75° C. in a heat exchanger, giving an enzymatically stable product, whose plant cells had been opened up. This made the extraction of the juice easier. Any enzymes present were inactivated in this process, and the microbes are stabilized. This heating led to transformations in the crude vegetable, which could be recognized in the dejuiced vegetable formed in a decanter where the vegetable juice was separated off.

The finely ground and possibly heated vegetable was pumped into a decanter, a press or a centrifuge, where the vegetable juice was separated from the vegetable. The vegetable juice contained the readily soluble constituents, such as sugars. The insoluble constituents mainly stayed in the dejuiced vegetable, while the other constituents were distributed over the vegetable juice and the dejuiced vegetable. In the separation of the vegetable juice, the decanter, the press or the centrifuge was adjusted such that the juiced vegetable had a moisture content of 55% or more, so that the juiced vegetable is easy to mix and knead with protein-containing materials, such as a dough or paste.

The production of carrot juice started with carrots containing about 1% of protein, 0.2% of fat, 5.2% of carbohydrates (including sugars), 3.4% of fibres, 2.0% of other dry matter and about 88% of water. The removal of the carrot juice, which contained about 7.5% of carbohydrates (including sugars), 2% of other dry matter and about 90% of water, left behind a dejuiced vegetable consisting of about 2.9% of protein, 0.6% of fat, 5.2% of carbohydrates (including sugars), 9.7% of fibres, 2% of other dry matter and about 84% of water. In this example, 650 grams of carrot juice were removed from 1000 grams of carrots, and 350 grams of dejuiced carrot remained.

The data above refer to carrots but are also representative of other vegetables, such as pepper, cauliflower, broccoli, leek, beetroot, cucumber, and various types of lettuce and cabbage (Brassica), but the values vary with the type of vegetable and the season.

The finely ground vegetable can be juiced in a separating device, such as a decanter as mentioned above. The use of other devices, such as a press or a centrifuge, is also possible.

The vegetable juice obtained was removed through pipes, possibly pasteurized or preserved in another way, and then placed in packets, tins or bottles, or otherwise transported to the consumer.

The dejuiced vegetable was allowed to fall by gravity as a moist product from the separating device onto a conveyor belt or into the trough of a screw conveyor in order to transport it to a container for further processing. The dejuiced vegetable was optionally cooled or mixed with a preservative, or else treated by another method in order to reduce its microbial count.

The dejuiced vegetable collected in the containers can be processed directly by the method described below. The dejuiced vegetable is generally transported to another plant or another location for intermediate storage at a low temperature. The containers filled with the dejuiced vegetable are closed here with lids in order to keep the dejuiced vegetable under hygienic conditions. Other measures aimed at the maintenance of hygiene can also be applied.

In a test, the dejuiced vegetable was mixed with fat, water and protein (in the form of finely comminuted meat), as well as with processing aids, such as starch, in order to produce a dough or paste. In this example, the dough or paste contained 23% of dejuiced carrot; lower percentages were also tried successfully, and higher percentages are also expected to be possible. The dough or paste was filled into a sausage case to produce a sausage; this case was tied off and the sausage was heated in a water bath of 85° C. for a few hours. After cooling, the sausage was found to have a surprisingly good texture, a good colour, an interesting taste and the required moisture content. The addition of about 20% of dejuiced carrot to a Dutch-type salami was found to raise the average moisture content of the latter from 57% to about 63% without altering its texture.

In another test, the dough was made with flour and water and contained 20% of dejuiced carrot. The dough was used to bake bread in an oven, which had an excellent flavour and a very good texture and structure. Biscuits were also baked and puff pastry prepared in a similar way. The use of gluten-free flour in combination with the dejuiced vegetable gave a high-fibre bread that was free of gluten. This enables people with a gluten allergy to eat bread and other bakery products that stimulate the intestinal activity.

In another application, the dejuiced vegetable was added to a paste for making rissoles and croquettes. The dejuiced vegetable can ensure here too the right texture for the fried product, and the amounts of fibres, fat and carbohydrates can be favourably affected.

1. A method for making a food product that is suitable for human consumption, has a firm texture and is made from a mixture of protein-containing ingredients comprising dough or paste for sausage products, meat products or bread and vegetable, characterized in that finely ground vegetable is first dejuiced in a separating device, such as a decanter, a press or a centrifuge, and the dejuiced vegetable is then kneaded into the protein-containing ingredients without further processing.

2. The method for making a food product according to claim 1, whereby the dejuicing of the vegetable in the separating device is stopped before the moisture content of the dejuiced vegetable falls below 55%.

3. The method for making a food product according to claim 1, whereby the food product is a dough or paste containing protein, fat, starch, processing aids and the dejuiced vegetable, which dough or paste is heated for some time after the addition of the dejuiced vegetable.

4. The method for making a food product according to claim 1, whereby, prior to dejuicing, the vegetable is finely grounded in a grinding device which is adjusted such that the finely ground product is pumpable.

5. The method for making a food product according to claim 4, whereby the grinding device is adjusted such that 80% of the particles of the pumpable product have a size smaller than 2.5 mm.

6. The method for making a food product according to claim 1, whereby the vegetable is heated for a short time prior to dejuicing.

7. The method for making a food product according to claim 1, whereby the separating device is adjusted such that, when the vegetable juice is being extracted from the vegetable, less than 50 wt % of the original amount of vegetable remains as dejuiced vegetable.

8. The method for making a food product according to claim 1, whereby, directly after the extraction of the juice, the dejuiced vegetable is cooled and/or temporarily preserved in some other way and/or stored before being added to the protein-containing ingredients.

9. The method for making a food product according to claim 1, whereby the food product with a firm texture consists of a mixture of protein-containing ingredients containing at least 5 wt % of dejuiced vegetable.

10. The method for making a food product according to claim 1, whereby the food product with a firm texture consists of a mixture of protein-containing ingredients comprising dough or paste for sausage products, meat products or bread containing at least 20 wt % of dejuiced vegetable.

11. An ingredient for addition to dough or paste for sausage products, meat products or bread suitable for human consumption, comprising dejuiced vegetable with a moisture content of at least 55%.

12. The ingredient according to claim 11, whereby the dejuiced vegetable is subjected to an after-treatment to reduce its microbial count.

13. A dough or paste used for making sausage products, meat products or bread suitable for human consumption, which dough or paste is composed of protein, fat, starch, processing aids and vegetable, amongst other ingredients, characterized in that the vegetable is added in the form of a kneadable dejuiced vegetable.

14. The dough or paste according to claim 13, whereby the fibre content of the dejuiced vegetable is at least twice as high as the fibre content of the vegetable.

15. The dough or paste according to claim 13, whereby 80% of the particles of the dejuiced vegetable have a size smaller than 2.5 mm.

16. Meat products made from or containing the paste according to claim 13, whereby the paste is partly composed of finely ground meat, and the paste is preferably warmed for a few hours at most.

17. Bread or pastry products made from or containing the dough according to claim 13, whereby the dough is baked in an oven.

18. Products for frying, baking and roasting, such as rissoles, spring rolls and fish-fingers, made from or containing the paste according to claim 13, whereby the product is cooked in frying oil or in an oven.
